(19) United States
(12) Patent Application Publication
(10) Pub. No.: US 2008/0279727 A1
(43) Pub. Date: Nov. 13, 2008

(54) Polymeric Fluid Transfer and Printing Devices

(76) Inventor: Robert C. Haushalter, Santa Clara, CA (US)

Correspondence Address: DUANE MORRIS LLP - Princeton, PO BOX 5203, PRINCETON, NJ, 08543-5203, US

(21) Appl. No.: 11/817,560

(22) PCT Filed: Mar. 1, 2006
(86) PCT No.: PCT/US06/07248

§ 371 Date: Apr. 1, 2008

Related U.S. Application Data
(60) Provisional application No. 60/661,833, filed on Mar. 1, 2005.

(51) Int. Cl. C25D 1/00; B01L 3/00; B01L 9/00

(52) U.S. Cl. 422/100; 205/69; 422/104

(57) ABSTRACT

A method and apparatus for making a polymeric printhead having one or more pins for fluid transfer and printing, including the steps of forming a positive mold of the printhead using a bulk micromachining process, forming a negative mold of the printhead from the positive mold using an electroforming process, and forming the printhead from a polymeric material in the negative mold, the polymeric printhead being operative for fluid transfer and/or printing. Also, printheads and pins, holders and dispensing trays microfabricated from a polymeric materials for fluid transfer and printing.

### RELATED APPLICATIONS

This application claims the benefit of U.S. Provisional Application No. 60/661,833, filed on Mar. 1, 2005, the entire disclosure of which is incorporated herein by reference.

U.S. Patent Publication 20030166263 A1, entitled MICROFABRICATED SPOTTING APPARATUS FOR PRODUCING LOW COST MICROARRAYS.

### FIELD OF THE INVENTION

This invention relates to fluid transfer and printing devices. More particularly, the invention relates to improved fluid transfer and printing devices and methods and apparatus for producing same.

### BACKGROUND OF THE INVENTION

Microarray technology is emerging as one of the principal and fundamental investigational tools for a very wide variety of biological problems. Although the preparation of DNA microarrays for use in many types of analysis is one of the main applications today, it is clear that the basic concept of easily obtaining huge amounts of data from a rapid and relatively simple-to-use platform is set to penetrate most areas of biology and may find comparably broad use in chemistry and material science. Such diverse areas of biology including, without limitation, genetics, population biology, immunology, rational drug design, genetic engineering and therapies, protein engineering, developmental biology and structural biology, would benefit from a rapid infusion of an inexpensive version of microarray technology. As with many other areas of technology, the true power of microarray technology will only become fully utilized when it is efficiently coupled to other related or complementary technology. For example, the coupling of an inexpensive, and easy to use microarray technology to amplification techniques may allow an almost “real time” look into the biochemical machinery and mechanisms of a single cell as a function of time after various biochemical challenges.

In order to derive maximum benefit from a young technology area such as that of microarrays, the technology needs to be simple, inexpensive to purchase and use and be of reasonable physical size. For microarray technology, this translates into a system that should give better performance than the best current system, in a more compact format at a much lower price.

Many embodiments of microarray-based experiments involve the following basic and common steps: after defining the question or problem to be addressed by the microarray based experiment, a sample is bound to a substrate, such as a glass slide treated with a reagent capable of covalently bonding the DNA to the glass substrate. The sample to be tested is then applied to the substrate.

There are three common methods used for applying a sample to a substrate, each with its own compliment of advantages and disadvantages. Some of the more important parameters for various dispensing devices are summarized in Table I below.

TABLE I

| | Microspotting | Piezoelectric/ | Solenoid/ |
|---|---|---|---|
| Parameter | Pin | Inkjet | Syringe |
| Spots/mm² | 4-100 | 4-25 | 2-4 |
| Volume printed (nL) | 0.5-2.5 | 0.05-10 | 5-200 |
| Adjustable volume | Need separate pin | Yes | Yes |
| Spot size (μm) | 75-400 | 120-180 | 250-500 |
| Spots/second | 64 | ~500 | ~40 |
| Robustness | Higher | Lower | Intermediate |
| Cost/spot | Least | Most | Intermediate |
| Loading volume of | 0.2-1.0 | 10 | 10 |
| dispensing device (μL) | | | |

a)

It is clear from the data in Table 1 that microspotting pins are a competitive technology in terms of speed, quality and cost. Accordingly, a large portion of these arrays are accomplished with high precision metal microspotting pins. Unfortunately, the metal microspotting pins are individually machined at costs up to $400 each. The high cost of the pins prohibit many laboratories from using microspotting pin technology. Moreover, the metal pins are susceptible to bending damage and complex features which may further the utility of the pins can not be fabricated using traditional machine shop fabrication methods.

Accordingly, improved and inexpensive fluid transfer and printing devices and methods and apparatus for producing same, are needed for use in microarray and other fluid transfer and printing applications.

### SUMMARY

In one embodiment, an apparatus for fluid transfer, the apparatus comprising a pin microfabricated from a polymeric material, the pin for transferring a predetermined volume of a fluid, the pin having a tip and a fluid reservoir communicating with the tip.

In another embodiment, a pin comprising a tip and a fluid reservoir communicating with the tip, wherein the pin is microfabricated from a polymeric material and is operative for transferring a predetermined volume of a fluid.

In a further embodiment, a holder for use in fluid transfer and printing, the holder comprising a first member and a first aperture formed in the first member for receiving a microfabricated pin for transferring a predetermined volume of a fluid, wherein the holder is microfabricated from a polymeric material.

In a still a further embodiment, a dispensing tray for use in fluid transfer and printing, the dispensing tray comprising a well for holding a fluid to be transferred by a microfabricated pin for transferring a predetermined volume of a fluid, wherein the tray is microfabricated from a polymeric material.

In yet another embodiment, a method comprising steps of forming a positive mold of an article such as a printhead or pin using a bulk micromachining process, forming a negative mold of the article from the positive mold using an electroforming process, and forming the article from a polymeric material in the negative mold, the polymeric article being operative for fluid transfer and printing.

### BRIEF DESCRIPTION OF THE DRAWINGS

FIGS. 1A-1D collectively show an embodiment of a unitarily formed polymeric printhead wherein FIG. 1A is an elevational view of the printhead, FIG. 1B is a side elevational view of the printhead, FIG. 1C is a detailed view of the circled area in FIG. 1B, and FIG. 1D is an enlarged view of one of the pins of the printhead and its associated springs.

FIGS. 2A, 2B, 3A, 3B, 4A, 4B, 5A, 5B, 6A, 6B, 7A, and 7B are plan and cross-sectional views depicting the making of a positive master mold.

FIGS. 8A and 8B are plan and cross-sectional views depicting the making of a negative embossing mold.

FIGS. 9A-9C are elevational views depicting the molding of a printhead.

FIGS. 10A and 11A are elevational views of corresponding printhead sections.

FIGS. 10B and 11B are elevational side views of the corresponding printhead sections of FIGS. 10A and 11A.

FIG. 12A is an exploded view of a plurality of printheads that will form a two-dimensional array printhead assembly.

FIG. 12B is an elevational view of a printhead assembly.

FIG. 12C is a top view of a two-dimensional array printhead assembly.

FIG. 13A is an elevational view of an embodiment of a pin.

FIG. 13B is a side elevational view of the pin of FIG. 13A.

FIG. 13C is a view of the dispensing tip section of the pin of FIG. 13A.

FIG. 14A is a plan view of a section of a holder according to one embodiment.

FIG. 14B is an elevational view of the holder of FIG. 14A.

FIG. 15A is an elevational view of the holder according to a second embodiment.

FIG. 15B are elevational views depicting the operational advantage of the holder of FIG. 15A.

FIG. 16 is an elevational view of a section of a dispensing tray according to one embodiment.

### DETAILED DESCRIPTION OF THE INVENTION

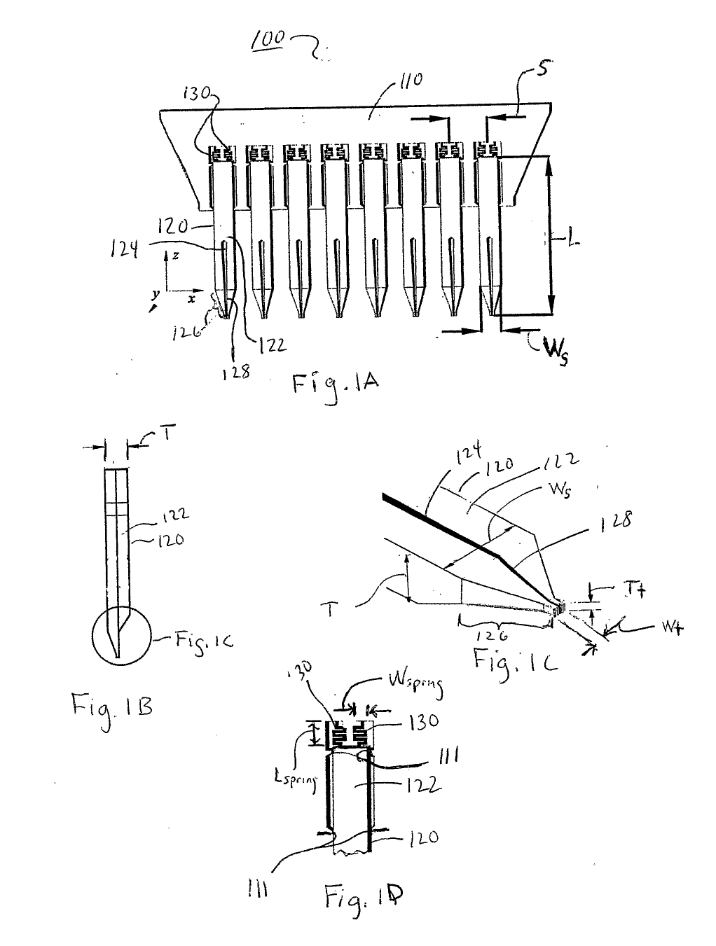

FIGS. 1A-1D collectively show an embodiment of a unitarily formed polymeric printhead 100 comprising a head member 110 and a linear array of polymeric pins 120 each of which is connected to the head member 110 by flexible springs 130. Each of the pins 120 may comprise a shaft 122 and a printing tip section 123. The printing tip section 123 may comprise a tapering, channel-like fluid or sample reservoir 124, a dispensing or print tip 126 and a slot 128 extending through the print tip 126 and communicating with the reservoir 124. The head member 110 includes collimating surface portions 111 (FIG. 1D) immediately adjacent the pins 120, to collimate the pins 120 thereby preventing them from tilting during printing on a substrate. The slot 128 enables a fluid (e.g., a sample in solution) to be drawn into and stored in the reservoir 124, transferred, and then dispensed at the print tip 126. It is contemplated that in other embodiments, the polymeric pins, may comprise holes, slots or other orifices into which a fluid (e.g., printing fluid) may be passively imbibed, held and transferred from one location to another.

The polymeric printhead 100 may be molded in a negative embossing mold which is fabricated in a method that uses a micromachining process. In one embodiment, the micromachining process may be a bulk micromachining process. Bulk micromachining involves the selective removal of defined regions of a substrate, on a millimeter to nanometer scale, to form a micro-mechanical structure by an etching process. The substrate may be a single crystal silicon wafer or other suitable substrate material. The use of bulk micromachining allows the one or more pins 120 of the printhead 100 to be precisely molded with the requisite feature sizes, and to a lesser extent surface finish, such that a print fluid contained in the printing reservoir 124 of the pin 120 can be passively dispensed from the print tip 126 of the pin 120 in a desired manner. In addition, the negative embossing mold can be made much less expensively using bulk micromachining and electroforming, and the mold can be made considerably faster and with a much higher precision and accuracy, than making a mold by traditional die making techniques.

Etching is the primary means by which a third dimension of a bulk micromachined structure is obtained from a planar photolithographic process. In the case of the printhead 100, the print tip 126, the flexible spring 130 and the printing fluid reservoir 124 are all three dimensional structures. There are generally two basic methods for etching the substrate: anisotropic wet etching and dry etching. In both etching methods, the pattern to be etched in the substrate may be defined by a photolithographic process. The very high accuracy and precision with which a photomask may be prepared is reflected in the accuracy and precision of the substrates to be etched.

The negative embossing mold used for molding the printhead may be fabricated from a “positive” master mold. The positive master mold has the same geometry as the final polymer part to be molded. In one exemplary embodiment, the positive master mold may be partially or entirely bulk micromachined from a silicon wafer using wet and dry etching methods. The anisotropic wet etching method, in some exemplary embodiments comprises etching in aqueous potassium hydroxide (KOH) at 80° C. When the substrate comprises a single crystal silicon wafer, the KOH etchant attacks the <100> planes of the silicon wafer many times faster than the <111> planes, and therefore, may be used to etch square-shape depressions or trenches with ˜55° <111> sidewalls, into (100) the single crystal silicon wafer. The wet etching method allows many silicon wafers to be inexpensively etched in parallel, however, the etchant only cuts along certain crystallographic planes and not at arbitrary angles.

A very selective dry etching method is Deep Reactive Ion Etching (DRIE). DRIE is well known in bulk micromachining art for its ability to etch very high aspect ratio trenches. The DRIE method uses a plasma technique whereby an etching system rapidly pulses etchant and passivator gasses alternatively over the wafer or substrate. This etch can cut a narrow (<10 to ˜500 micron [μ or μm=10⁻⁶ m=10⁻³ mm] wide) trench through a wafer substrate up to 500μ deep, such as the earlier mentioned single crystal silicon wafer, with sidewalls vertical to within a few degrees over the depth of the cut. The DRIE method may be used to etch, with very high precision, any arbitrary shape into the substrate, however, only one substrate at a time may be processed. Reactive Ion Etching (RIE) is somewhat similar to DRIE in that it cuts a pattern with a plasma, however, the features etched by RIE are isotropic since the etching step is present but not the passivation steps found in DRIE methodologies. Hence, RIE is typically used for etching features that have relatively shallow etch depths or where vertical sidewalls on the etched trenches are not important.

The positive master mold may be used for fabricating the negative embossing mold. In one embodiment where the positive master mold is at least partially fabricated from silicon, the negative embossing mold may be fabricated by plating the positive master mold, after suitable pretreatment to render the silicon more highly conductive, with a relatively thick (0.5 mm to several millimeters) layer of a metal. This process is also known as electroforming. In an exemplary embodiment, plating may be performed by a conventional electrodeposition process. In one preferred embodiment, the negative embossing mold is electroformed from a Ni—Co alloy.

The polymeric printhead, which has the same features as the positive master mold, may be molded in the negative embossing mold using any suitable molding process. Any suitable polymeric material including, without limitation, polycarbonates and polymethylmethacrylates, polyolefins, polyetherketones or any other thermoplastic polymers may be used for molding the printhead.

An embodiment of a method of making the printhead will now be described. For illustrative purposes only, the method will be described as it relates to making printhead 100 collectively shown in FIGS. 1A-1D wherein the linear array of pins 120 is formed by eight individual pins 120, and wherein the pins may each have a length of about 28 mm, the shaft 122 of each pin 120 may have a width Wₛ of about 1 mm and a thickness Tₛ of about 400μ, the print tip 126 of each pin 120 may have a width Wₜ of about 100μ and a thickness Tₜ of about 100μ, and the slot 128 of the print tip 126 may have a width of about 1 to 100μ. The springs 130 may have a length L_{spring} of about 2-4 mm, a width W_{spring} of about 200 μm and a thickness of about 40-50 μm (not visible). Quantitative estimates of the print tip pressure of a pin 120 and spring 130 as dimensioned immediately above, for about a 50-75 μm over-travel in the z direction, indicate that the print tips 126 are more than strong enough not to deform upon printing. The linear array of pins 120 may have any center-to-center pin spacing S which is consistent with the methods described herein for fabricating the positive and negative molds. Over-travel may be defined herein as the distance, in the z direction, that the print tip would have traveled had its downward movement not stopped by contacting the substrate surface. Over-travel may also be defined as the distance the printhead travels in the z direction after the print tip touches substrate surface. Examples of such center-to-center pin spacings S include, without limitation, 4.5 mm (SBS 384 format), 2.25 mm (1536 format), and 1.125 mm (6144 format). These standard spacings of 4.5 mm, 2.25 mm, etc., which are familiar to those of ordinary skill in the art, are from the Society of Biomolecular Standards (SBS) standard microtiter plate layouts. One of ordinary skill in the art will appreciate that the method to be described may also be used for making printheads having pins and springs of other configurations and dimensions.

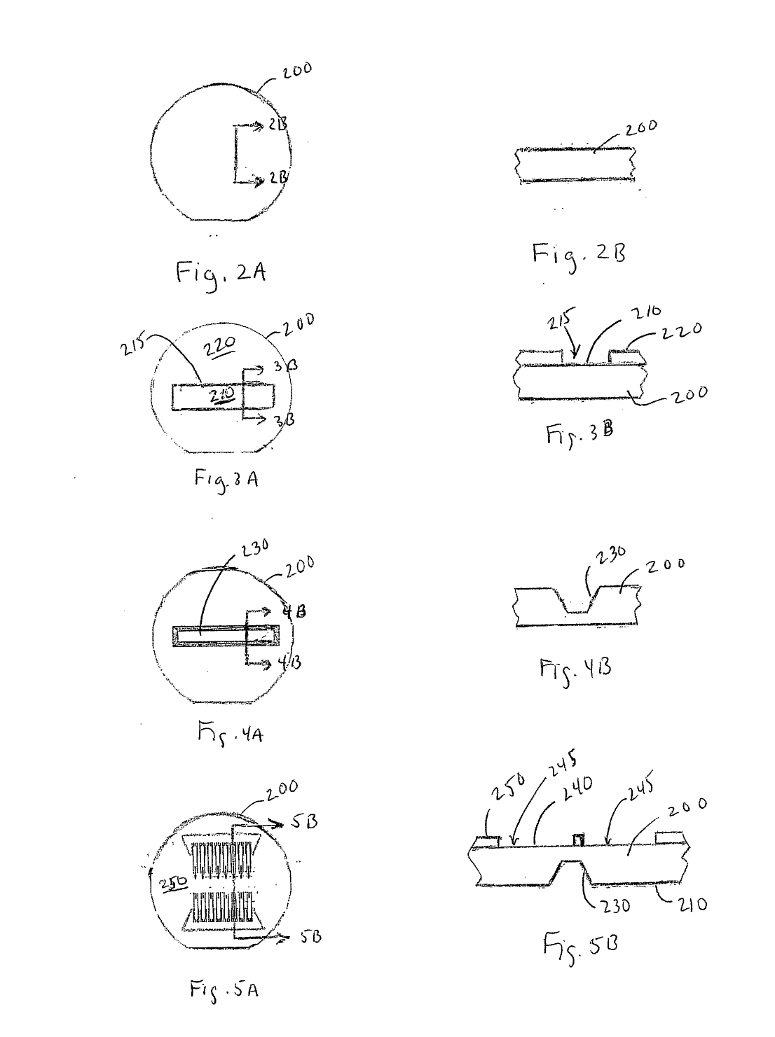

The embodiment of the method commences with the fabrication of the positive master mold 300 (FIGS. 7A and 7B) from a substrate, using in one example, the earlier described bulk micromachining process. The substrate may comprise an oxidized, silicon wafer 200 or other suitable substrate, as shown in plan and cross-sectional views of FIGS. 2A and 2B. In one embodiment, the silicon wafer 200 may be a single crystal silicon wafer having a (100) orientation, a diameter of about 100 mm and a thickness of about 200μ. In some embodiments, a positive master mold for molding up to three (3) eight pin subarrays can be fabricated on a single 100 mm diameter silicon wafer. It is contemplated that wafers having other diameter and thickness dimensions and orientations may also be used in the method.

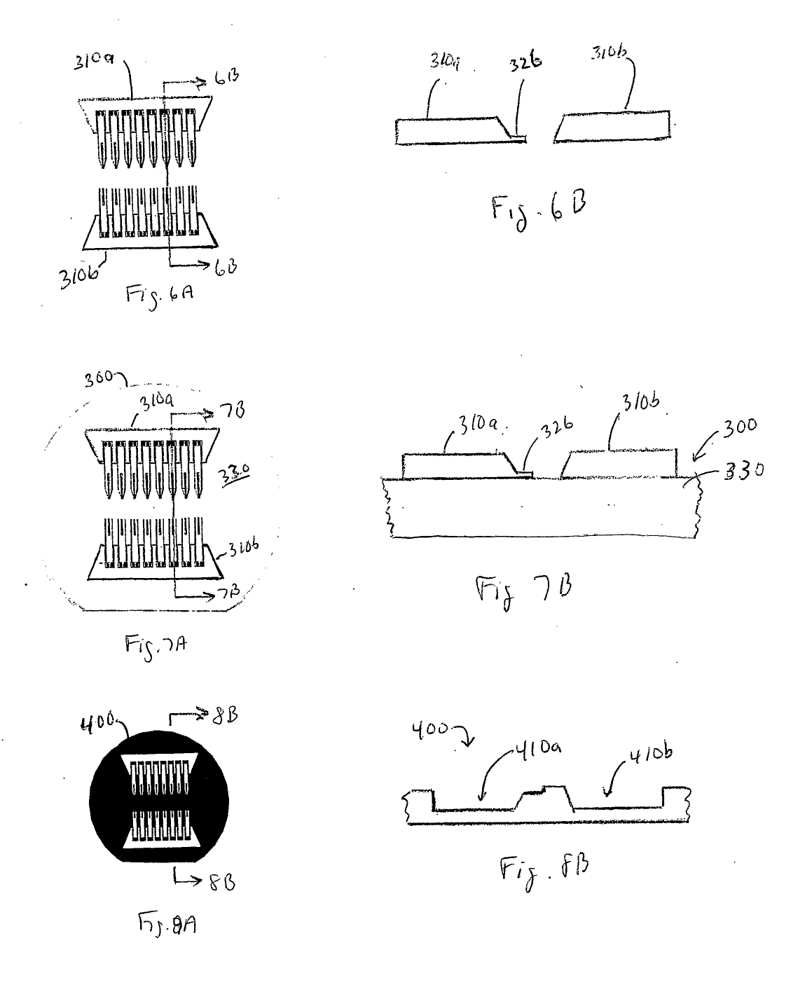

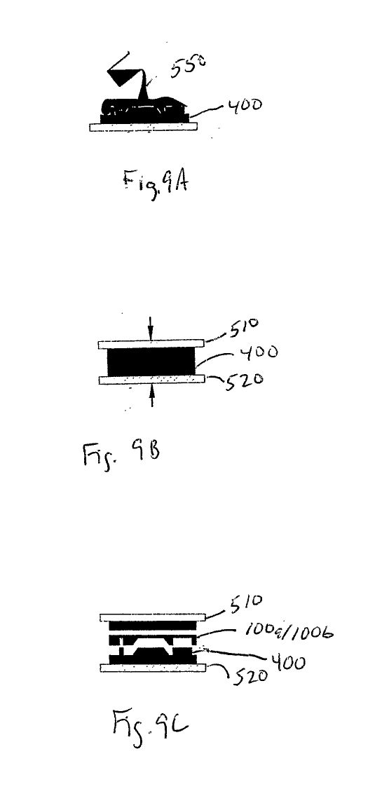

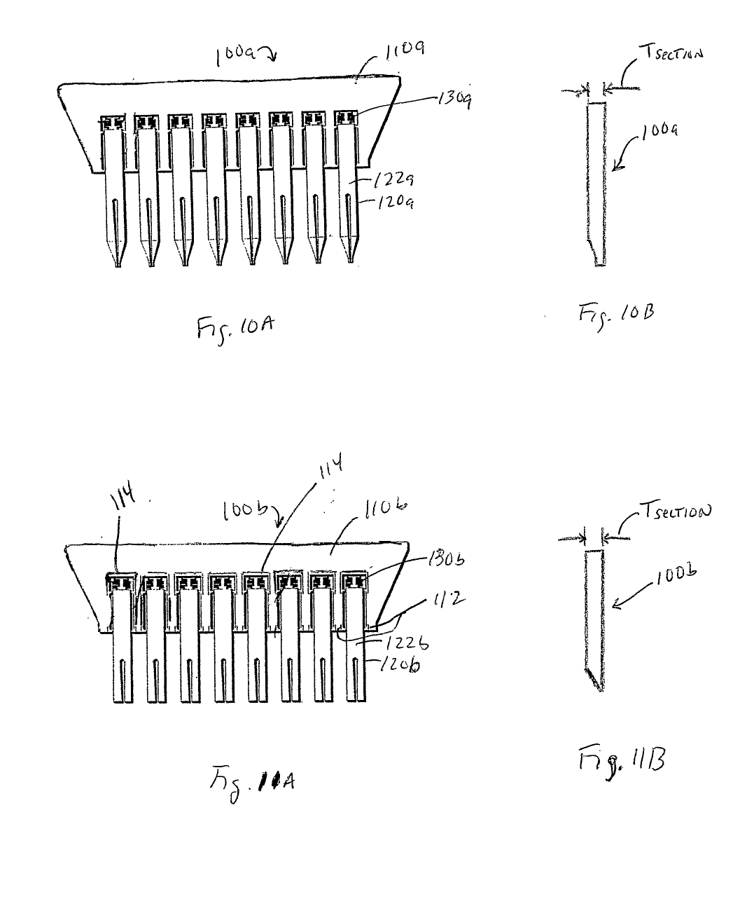

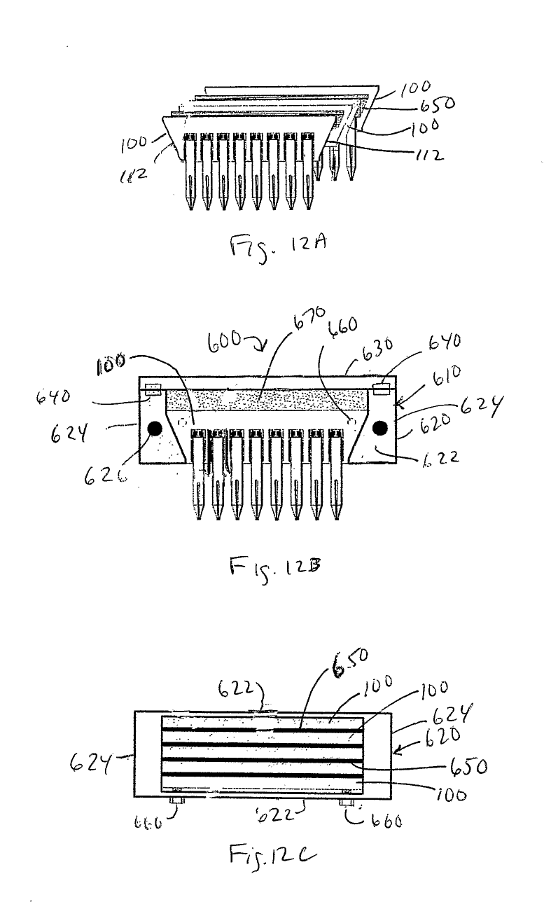

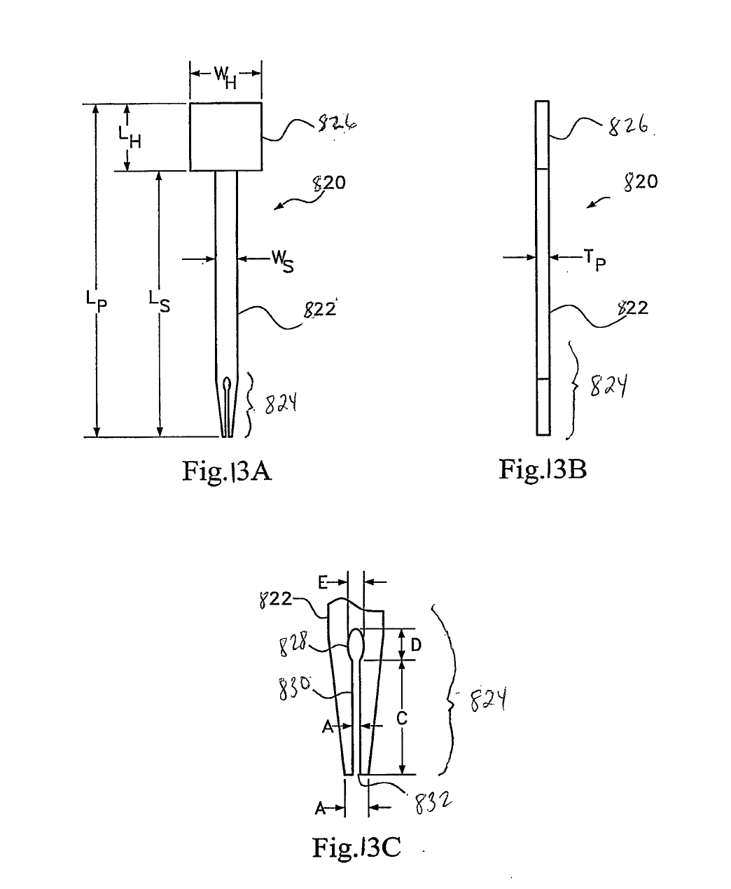

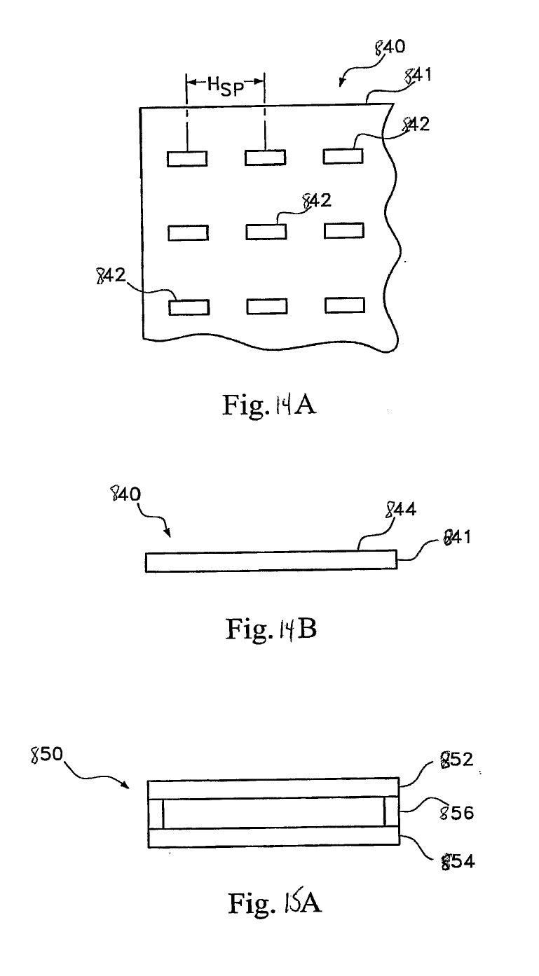

To create the positive master mold the silicon wafer 200 is selectively patterned photolithographically to expose one or more regions on the wafer surface which will be etched. A protective layer of silicon dioxide (not shown) is selectively removed by means of exposing certain regions of the oxide in a standard photolithographic process followed by dissolution of the exposed oxide from a first side 210 of the wafer 200. The exposed regions of bare silicon are then etched on the first side 210 of the wafer 200 to create a series of depressions or trenches (mold features) which may be configured and dimensioned to form the printing tips of the pins during the molding process. In a preferred embodiment, patterning may be performed by photolithographically transferring the depression design to the first side of the wafer via a photoresist etch-mask 220, as shown in the plan and cross-sectional views of FIGS. 3A and 3B and etching the exposed portions 215 of the first side 210 of the wafer 200 using the earlier described anisotropic wet etching process. The etching process is typically performed to a depth that will provide the desired printing tip thickness in the molded printhead (e.g., etching would be performed to a depth of about 100μ in a 200μ thick wafer for a printing tip design thickness of 100μ). After patterning, the etch-mask 220 may be removed from the first side 210 of the wafer 200. FIGS. 4A and 4B are plan and cross-sectional views of the wafer 200 after performing a wet etch process and removing of the etch-mask 220. Reference numeral 230 denotes one of the series of depressions formed in the wafer 200 using the wet etch process.

Next, a protective layer of silicon dioxide (not shown) may be formed e.g., thermally grown over the patterned first side 210 of the silicon wafer 200. The wafer 200 is then flipped over and the protective layer of silicon dioxide (not shown) is removed from the opposite, second side 240 of the wafer 200. The second side 240 of the wafer 200 is patterned to form the remaining mold features, which in one embodiment (e.g., the embodiment shown in FIGS. 5A, 5B, 6A and 6B) are provided by two corresponding mold sections, each of which will form a section (e.g., about one longitudinal half) of the printhead 100, wherein only the mold section includes the mold features that will form the print tips 126 of the pins 120. It should be understood, however, that in other embodiments, the positive master mold may comprise a single mold, or a mold formed by more than two mold sections. The patterned mold features are configured and dimensioned to form the remaining structures of the printhead 100 including, without limitation, the shafts 122 of the pins 120, the reservoirs 124 of the pins 120, the printhead member 110, and the springs 130, during the molding process. In a preferred embodiment, patterning of the second side 240 of the wafer 200 may be performed by photolithographically transferring the aforementioned mold features to the second side 240 of the wafer 200 via a photoresist etch-mask 250, as shown in the plan and cross-sectional views of FIGS. 5A and 5B and etching the exposed portions 245 of the second side 240 of the wafer 200 using the earlier described DRIE process. The etching process is typically performed to a depth equal to the thickness of the wafer 200 (e.g., etching would be performed to a depth of about 200μ in a 200μ thick wafer) and less in the areas of the wafer 200 already thinned by the previously described etch process. FIGS. 6A and 6B are plan and cross-sectional views of the wafer 200 (now mold sections 310a, 310b) after DRIE etching and removal of the DRIE etch-mask. Reference numeral 326 denotes a print tip mold feature for forming one of the print tips 126 during molding of the printhead 100, as described further on.

To complete the positive master mold 300, the mold sections 310a, 310b may be bonded to a base substrate or wafer 330. In one embodiment where the mold sections 310a, 310b are composed silicon, an anodic bonding process may be used to attach the mold sections 310a, 310b to a base substrate made of a glass having the substantially the same thermal expansion coefficient as the material of the mold sections 310a, 310b, e.g., silicon. Several types of borosilicate glasses, such as Corning 7740, are suitable for the base substrate or wafer 330. The anodic bonding process is well known to those skilled in the micromachining art, and comprises, in one embodiment, forming (e.g., thermally growing) a silicon dioxide (oxide) layer over the silicon mold sections 310a, 310b and configuring the mold sections 310a, 310b as an anode in a solid state electrochemical cell with the base substrate 330 (composed of e.g., borosilicate glass) configured as a cathode. Next, a voltage (e.g., ˜500V at 400-450° C.) is applied between the mold sections 310a, 310b and the base substrate 330, which causes sodium ions in the glass base substrate in the vicinity of the silicon-glass interface to migrate toward the base substrate cathode and the sodium depleted region chemically bonds to the oxide on the silicon mold sections 310a, 310b anode thereby forming a continuous hermetic seal.

FIGS. 7A and 7B are plan and cross-sectional views of the completed, positive silicon master mold 300. As shown, the mold sections 310a, 310b of the positive master mold 300 define raised three-dimensional printhead feature embossments which may be used for forming the negative embossing mold 400 (FIGS. 8A and 8B). The base substrate or wafer 330 may have a thickness that is substantially greater than the thickness of the mold sections 310a, 310b. In one embodiment, where the mold sections 310a, 310b are each about 200μ in thickness, the base substrate or wafer 330 may comprise a silicon wafer having a thickness of about 500μ.

The completed positive master mold 330 is used in the next step of the method for fabricating the negative embossing mold 400. In one embodiment, the negative embossing mold may be fabricated by forming a relatively thick layer (from about 0.2 mm to several mm thick) of a metal on all surfaces of the embossments (mold sections 310a, 310b) of the positive master mold 300, and separating the metal layer, which forms the negative embossing mold 400, from the positive master mold 300. The completed negative embossing mold 400 is shown in the plan and cross-sectional views of FIGS. 5A and 5B. The negative embossing mold defines three-dimensional printhead feature molding depressions 410a, 410b which are negative replicas of raised three-dimensional printhead feature embossments (mold sections 310a, 310b) of the positive master mold 300. The negative embossing mold 400 may then be used as a mold for molding the polymeric printhead 100.

In order to function as the cathode in the electroforming process, the master mold is rendered more highly conductive by the vapor deposition of a conductive metal all over the surfaces of the mold onto which the electroform will be grown. In one embodiment, the layer of metal forming the negative embossing mold 400 may be formed by a two step process. In the first step, a thin metal film (about 50-100 nm), such as gold, is deposited on the surfaces of the embossments (mold sections 310a, 310b) and other surfaces of the positive master mold 300. The thin metal layer sensitizes or primes the embossment surfaces (and the other surfaces) of the positive master mold 300, thereby making the initial deposit of the thick layer of metal, which will form the three-dimensional printhead feature molding depressions 410a, 410b of the negative embossing mold 400, smoother and more uniform. The thin metal layer may also act as a “mold release agent” to aid in releasing the negative embossing mold from the positive master mold. In the second step, the positive master mold 300 with the thin layer of metal deposited thereon, is used as a cathode in an electroforming process to deposit the relatively thick metal layer. In one embodiment, the relatively thick metal layer may be composed of a Ni—Co alloy.

The completed negative embossing mold 400 is then used in a suitable molding process, such as compression molding, injection molding, resin casting, rolling, embossing, and stamping, to mold the polymeric printhead 100. For example and not limitation, if compression molding is selected for the molding process, the raw polymeric material 550 is deposited into the mold 400, as shown in FIG. 9A. The raw polymeric material 550 may be provided in any suitable form such as a particulate resin (of a particle size from several microns to several millimeters) or sheet stock (of a thickness of about one micron up to several inches thick). If the finely powdered resin is used, a layer of the powdered resin should be deposited to a uniform thickness in the negative embossing mold. As mentioned earlier, the polymeric material 550 used for molding the printhead 100 may comprise any suitable polymeric material, including without limitation, polycarbonates and polymethylmethacrylates or any thermoplastic polymer.

Referring to FIG. 9B, the negative embossing mold 400 is then mounted in a press, which in one embodiment, may comprise generally planar upper and lower metal platens 510 and 520, respectively that may be heated. The upper and lower metal platens 510 and 520 in some embodiments may comprise resistively heated thermostatted metal blocks. The negative embossing mold 400 may be joined to the lower platen 520 by soldering the negative embossing mold 400 thereto so that the negative embossing mold 400 and lower platen 520 may be heated at a rate high enough to allow the press to make a sample every few minutes. The heated platens can be water or air cooled between cycles to increase the throughput of the molding operation. The heated upper and lower platens 510 and 520 are then pressed together (the upper platen may directly engage the negative embossing mold 400) with pressure sufficient to make the polymer flow and fill the mold, as depicted in FIG. 9B, to mold the polymeric printhead sections 100a, 100b.

During molding of the polymeric printhead components, the embossing mold and platens are maintained at temperatures generally 30-70° C. above the glass transitions temperature of the polymer with pressures in the 100-20,000 lbs/in2 range on embossing mold. To conserve the intricate features produced using this mold making technique, the molded printhead component or sections (parts) and the embossing mold must be separated before significant contraction can occur. When molding intricate features in a heated press using materials with different thermal expansion properties such as metal embossing mold and molded polymeric parts, the contraction of the molded parts and the mold at different rates can deform the features of the molded parts from the corresponding features of the mold relative to each other. This relative movement can cause deformation of the features replicated in the molded sections by the embossing mold and can be prevented by separating the molded parts before cooling is complete. It is often necessary to use a mold release agent, such as a silicone compound, to ensure that molded polymeric parts retain all of their fine features when separated from the embossing mold.

As shown in FIG. 9C, after the molding process is completed, the upper and lower platens 510 and 520 of the press are separated from one another and the polymeric printhead or printhead sections 100a, 100b are removed from the negative embossing mold 400. One problem that may occur with the compression molding process, even with the precision formed negative mold 400 disclosed herein, is that there may be thin (e.g., a few microns thick) regions of “flashing” remaining on the printhead sections, which is caused by separating the planar upper mold plate from the negative embossing mold after molding. In one embodiment, the thin flashing may be rapidly removed from the printhead sections 100a, 100b with a brief oxygen plasma treatment, that etches away thin films of organic material, which also removes any organic contaminants from the surfaces of the printhead sections 100a, 100b. Alternatively, the flashing can be removed by breaking it away or machining it away with, for example, a CNC milling machine, die cutting, grinding, chemically dissolving by dilute solvents, and thermal removal methods.

As mentioned earlier, the polymeric printhead 100 may be molded as a single component (not shown) or in multiple sections 100a, 100b as shown in the front/rear elevational views of FIGS. 10A and 11A and the corresponding side elevational views of FIGS. 10B and 11B. The multiple sections 100a, 100b (a two-section embodiment is depicted in FIGS. 10A, 10B, 11A, and 11B) may be adhesively bonded or mechanically fastened to one another to complete a basic, single linear array printhead. In one embodiment, each printhead section 100a, 100b, may have a thickness T_{section} of about 200μ, thus, when the two printhead sections 100a, 100b are assembled, the assembled printhead 100 will have a maximum thickness T of about 400μ (FIG. 1B). Any suitable adhesive bonding method, such as solvent bonding, may be used to assemble the printhead sections 100a, 100b. As shown in FIG. 11A, the surface of the head member section 110b (the bonding surface) may include first and second sets of grooves 112, 114 adjacent narrow openings, to provide areas for excess adhesive to collect, thereby preventing bonding of the shaft of the pins and the springs, rendering them nonfunctional.

In some embodiments, as collectively shown in FIGS. 12A-12C, two or more printheads 100 may be assembled together in a printhead holder 610 to form a two-dimensional (e.g., x and y directions) array printhead assembly 600 wherein each printhead 100 forms subarray. One embodiment of the holder 610 may comprise a rigid, four-sided rectangular sleeve member 620 formed by opposing side walls 622 and opposing end walls 624, and a corresponding removable lid 630 which closes an open end of the sleeve member 620 (FIGS. 12B and 12C). The sleeve member 620 may include threaded mounting holes 626 (FIG. 12B) for mounting the printhead assembly 600 in a printing apparatus (not shown). The lid 630 of the holder 610 may be secured to the sleeve member 620 using magnets 640 or any other suitable securing arrangement (FIG. 12B). The pinhead subarrays 100, in one embodiment, may be arranged in the y direction by alternately interleaving them in the sleeve member of the printhead holder 610 with rigid spacers 650 to provide a desired pin spacing and/or to prevent the pins 120 from contacting one another, thereby inhibiting up and down movement (z direction) of the pins 120 during printing (FIGS. 12A and 12B). The spacers 650 should be sized and configured to engage only the head members 110 of the subarrays 100, so as to not interfere with the up and down operation of the pins 120 (FIG. 12A). In some embodiments, the head members 110 of the subarrays 100 may have outwardly sloped side walls 112 which operate to center the subarrays 100 in the sleeve member 620 of the holder 610 (FIG. 12A). Screws 660 extending through one or both of the side walls 622 of the sleeve member 620 are provided in some embodiments for securely tightening the printhead subarrays 100 by pressing on the printhead members 110 disposed within the sleeve member 620 of the holder 610. In addition, some embodiments of the holder 620 may include a block of elastomeric foam 670 disposed between the tops of the printhead subarrays 100 and the lid 630, for holding the subarrays 100 in position within the holder 610 during printing. Although not shown, in other embodiments, one printhead (subarray) may be assembled in a printhead holder to form a one-dimensional (e.g., x direction) array printhead assembly.

In order to greatly improve the quality and reduce the number of missing spots when, for example, printing DNA or protein microarrays, it is necessary that the pins be individually compliant. This is necessary to accommodate any roughness on the surface of the substrate and to provide the appropriate degree of pressure on the print tips. There is an ideal printing pressure, neither too light or too strong, to obtain the best spot morphology. In the case of the polymeric pins, the individual compliance is provided by the associated springs coupling the pins to the printhead member as shown in FIGS. 1A, 1D, 12A and 12B. The print pressure is controlled by the amount the pin over-travels after initially touching the substrate.

The pins (of the printhead) must wet in order to take up the printing fluid even though the print tips may be submerged into a source plate well (not shown). It is possible to make an acrylic surface that retains good wetting properties for at least weeks or longer. This may be accomplished in one embodiment, by washing the pins for several days in ethanol, to remove any small polymer fragments or plasticizer, and then treating the pins in an O₂ plasma. Silicone polymers such as polydimethylsiloxane (PDMS) cannot be rendered hydrophilic for more than a few days presumably due to the migration of hydrophobic chains or short polymer pieces from the bulk. It is believed that well washed, highly crosslinked acrylates will be less susceptible to this problem.

To further enhance the wetting ability of the pins, some embodiments of the printhead may be molded from a polymeric material comprising a mixture of polymethylmethacrylate and poly(hydroxyethyl)methacrylate. In other embodiments, the wetting ability of the pins may be enhanced by applying surface grafting techniques to the pins. This may be accomplished either by reacting the pins with an appropriate silane or by grafting another polymer such as polyvinylalcohol onto the surface of the pins.

One of ordinary skill in the art will appreciate the ease, low cost and short time with which the negative embossing mold can be formed from the positive master mold. Thus, a very substantial benefit may be gained from the above described method, both design and manufacturing perspectives.

FIGS. 13A-13C collectively illustrate another embodiment of a pin 820, which may be made from a polymeric material using the methods described above. The pin 820 may comprise a generally rectangular shaft 822 with a printing tip section 824, and an enlarged, generally rectangular pin mounting head 826 disposed at the end of the shaft 822 opposite the printing tip section 824. The pin 820 may have a length L_{P} anywhere between about 10 μm and 100 mm and a thickness T_{P} anywhere between about 10 μm and 10 mm. The mounting head 826 may have a length L_{H} anywhere between about 2 μm and 20 mm and a width W_{H} anywhere between about 2 μm and 10 mm. The shaft 822 may have a length L_{S} anywhere between about 8 μm and 80 mm and a width W_{S} anywhere between about 2 μm and 10 mm. In one illustrative example, the pin 820 may have a length L_{P} of about 6 mm and a thickness T_{P} of about 200 μm, the mounting head 826 may have a length L_{H} of about 1 mm and a width W_{H} of about 1 mm, and the shaft 822 may have a length L_{S} of about 5 mm and a width W_{S} of about 500 μm.

One of ordinary skill in the art will of course appreciate that the shape and dimensions of the pin 820 may be varied. For example, the rectangular shaft 822 prevents the pin 820 from rotating in correspondingly shape slots 842 of a pin holder to be described further on. In other embodiments, the shaft 22 can be square, or be cylindrical and provided with other means which prevents rotation in the pin holder.

As best shown in FIG. 13C, formed essentially in the printing tip section 824 of the shaft 822 is a generally elliptical shaped aperture or sample holding reservoir 828, and an elongated slot or channel 830 that communicates with the sample holding reservoir 828 and extends to a dispensing (print) tip 832 of the shaft 822. The slot 830 enables a fluid (e.g., a sample in solution) to be drawn into and stored in the fluid reservoir 828 and then be dispensed at the dispensing tip 832 of the shaft 822.

The structures of the printing tip section 824 including but not limited to the reservoir 828, channel 830, and/or the dispensing tip 832, are configured and dimensioned to optimized the fluid transfer process (e.g., microspotting process).

The configuration and dimensions of the print tip section of the pins disclosed herein may be adjusted so that the volume of liquid sample deposited by the pin and/or the area of the spotted liquid sample (spot) can be varied as desired. It is contemplated that the configuration and dimensions of the printing tip section can be adjusted so that the volume of liquid sample deposited by each pin can be as large as about 0.1 milliliters (mL), as minute as about 10⁻⁴ picoliter (pL), or any volume between about 0.1 mL and 10⁻⁴ pL. Similarly, the configuration and dimensions of the printing tip section can be adjusted so that the area of the spotted liquid sample (spot) deposited by each pin can be as large as about 10 square millimeters (mm²), as minute as about 10⁻⁶ square microns (μm²), or any area between about 10 mm² and about 10⁻⁶ μm².

One of ordinary skill in the art will of course appreciate that the printing tip section of the pins disclosed herein may be configured in various other ways to optimize the fluid transfer process. For example, the surface or surfaces making up the dispensing tips may be smooth, textured, concave, convex, include one or more pores, channels, or nozzles or combinations of the same. Further, the printing tip section may be designed such that the entire shaft of the pin does not have to be submersed into the stock solution to be spotted, thereby obviating the time and material wasting pre-spotting procedure.

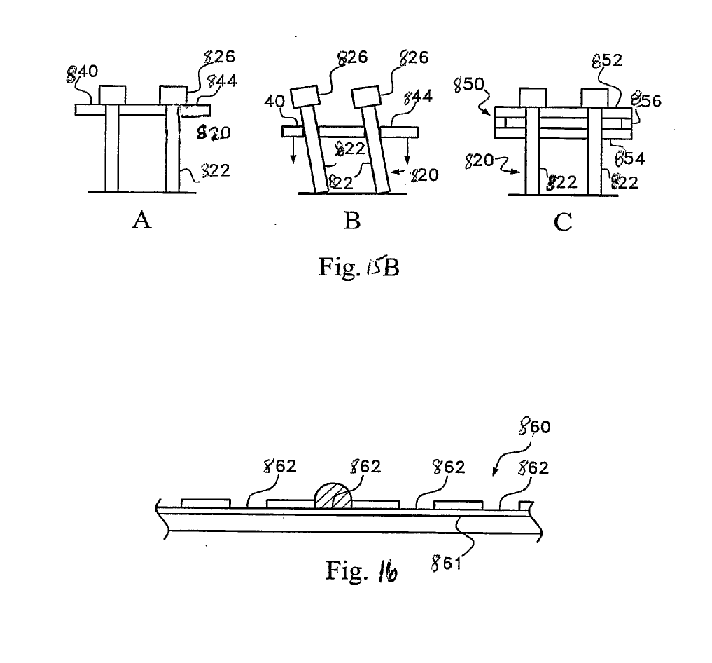

FIGS. 14A and 14B illustrate an embodiment of a pin holder 840 which may be used for holding the pin(s) 820 embodied in FIGS. 13A-13C. The pin holder 840 may be made from a polymeric material using the methods described above, and configured as a planar member 841 having an array of microfabricated slots 842 (e.g. rectangular in shape) extending therethrough, each of the slots 842 shaped and dimensioned to accept a pin 820. The configuration and dimensions of the pin holder 840 may be varied accommodate up to 100,000 pins 820. In one embodiment, the holder may be 10 cm by 16 cm. The configuration and dimensions of the slots 842 may also be adjusted to provide a pin density, i.e., the number of pins per unit area of the holder, of about 1 pin per 10 mm² of holder area to about 10⁶ pins per mm² of holder area. The printhead embodied in FIGS. 1A-1D may be configured and dimensioned to provide the above stated pin densities also. The pin density of the holder 840 is important as it determines the spot density of a resulting microarray produced by the holder 840 and pin 820 assembly. The slots 842 of the pin holder 840 are also configured and dimensioned to allow the shafts 822 of the pins 820 to be slip-fitted into the slots 842 in a frictionless manner with no lateral movement, and suspended by their mounting heads 826, which rest on the upper surface 844 of the pin holder 840, while preventing rotation of the pins 820 in the slots 842.

FIG. 15A illustrates a further embodiment of a pin holder 850 which may be used for holding the pin(s) embodied in FIGS. 13A-13C and made from a polymeric material using the methods described above. In this embodiment, upper and lower pin holders 852, 854 are connected or bonded together by a perimeter spacer 856 in a single unit referred to herein as a collimating holder. The collimating holder 850 is used to prevent the pins 820 from “tipping over” when touching a substrate, as shown in FIG. 15B. More specifically, when the pins 820 touch the substrate surface during printing, the pins 820 may be excessively raised out of the “non-collimated” holder 840 of the previous embodiment such that the mounting heads 826 no longer touch the upper surface 844 of the holder member 841 to prevent the pins 820 from tipping over. The collimating holder 850 solves this problem by providing the lower holder 854, which guides the bottom portion of the pin shafts 822 to maintain the vertical orientation of the pins 820 in the holder 850.

Additional increases in microarray printing speed may be realized using a multi-well dispensing tray 860. FIG. 16 illustrates an embodiment of a multi-well dispensing tray, which may be made from a polymeric material using the methods described above. The dispensing tray 860 may be configured as a planar member 861 having an array of microfabricated sample holding wells 862 defined in the member 861. The configuration and dimensions of the dispensing tray 860 may be varied accommodate up to 100,000 wells 862. The configuration and dimensions of the wells 862 may also be varied to provide a well density, i.e., the number of wells per unit area of the dispensing tray, of about 1 well per 10 mm² of dispensing tray area to about 10⁶ wells per mm² of dispensing tray area.

The pin embodied in FIGS. 13A-13C, the holder embodied in FIGS. 14A, 14B, 15A, and 15C, and the dispensing tray embodied in FIG. 16, are similar to those described in U.S. Patent Publication 20030166263 A1, entitled MICROFABRICATED SPOTTING APPARATUS FOR PRODUCING LOW COST MICROARRAYS, the entire disclosure of which is incorporated herein by reference.

In addition to microarray printing, the printhead and pins may be used in fluid transfer applications alone. For example, a polymeric pin may be used by dipping it into a solution A to pick up a specific volume of reagent. The pin may then be removed from solution A and dipped into another solution B for a time sufficient for the reagent to diffuse into solution B.

The polymeric printhead and pins may be used in many uses and applications. For example, the polymeric printhead and pins may be used in biology in microfluidic manipulation applications wherein the polymeric printhead and pins may be used to transfer of small volumes of assorted materials, including but not limited to: nucleic acids (DNA and RNA, oligos) for printing microarrays, analysis of concentration, transfections/transformations, PCR (polymerise chain reaction), restriction enzyme analysis, qPCR/Taqman assays, sequencing reactions, DNA synthesis, in vitro transcription, translation of RNA, reverse transcription, and site-directed mutagenesis; proteins for protein arrays including antibody arrays, Elisas, Western blots, Dot blots, Far Western blots, peptides and protein domains, lectins, disease antigens, diagnostic markers, etc., and protein and peptide labeling; cells and other biologically relevant molecules for yeast, bacteria, larger cells with varying tip size, tissues, cell lysates, secretions, and phospholipids and lipids; and other materials such as drugs (compound library distribution), chemicals, and isotopes. The polymeric printhead and pins may also be used in screens for protein crystallization conditions and the like; colorimetric/light or other detection assays for enzymatic or other protein activity, i.e. Xgal, pyrene for actin polymerization, alkaline phosphatase/BCIP, fluorimetry, anisotropy, etc.; assays to determine concentrations of substances, i.e. BCA, Coomassie, Bradford, Syber Green, etc.; growth of cell cultures en masse; miniaturization of preexisting assays; and cherry-picking to retrieve substances from arrays.

Other methods may be used for fabricating the polymeric printheads and pins. For example, the polymeric printheads and pins may be fabricated using laser cutting methods. Laser cutting may be used to cut polymers such as polyimide, polyacrylic wafers to make the printheads and pins. Laser cutting may be used to make pins with relatively larger tips in the range of 200-600 microns or higher which can be used for making low density arrays for diagnostics. The polymeric printheads and pins may be fabricated from polymeric films and sheets using E-beam cutting methods, die cutting and computer numerically controlled (CNC) cutting (for making fluid transfer pins which do not require fine featured tips, and micro grit blasting (which selectively remove regions from acrylic films and sheets).

In other embodiments, the negative embossing mold may be made from the positive master mold by casting the mold from molten metal, hard plastics, such as PEEK, with relatively high melting points, including thermoset polymers.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. An apparatus for fluid transfer, the apparatus comprising:
a pin microfabricated from a polymeric material, the pin for transferring a predetermined volume of a fluid, the pin having a tip and a fluid reservoir communicating with the tip.

2. The apparatus according to claim 1, further comprising a holder microfabricated from a polymeric material, the holder having a first member for holding the pin.

3. The apparatus according to claim 2, wherein the holder further comprises a second member for collimating the pin.

4. The apparatus according to claim 1, further comprising a head member having surfaces for collimating the pin.

5. The apparatus according to claim 1, further comprising a head member and a spring coupling the pin to the head member.

6. The apparatus according to claim 1, further comprising at least a second pin, the pins forming an array.

7. The apparatus according to claim 6, further comprising a dispensing tray microfabricated from a polymeric material, the dispensing tray having an array of wells corresponding to the array of pins, for holding liquid to be transferred by the array of pins.

8. The apparatus according to claim 6, wherein the array of pins comprises up to 100,000 pins.

9. The apparatus according to claim 7, wherein the array of pins comprises up to 100,000 pins.

10. The apparatus according to claim 6, wherein the array of pins form a pin density between about 10⁻⁴ and 10⁶ pins/mm².

11. The apparatus according to claim 7, wherein the array of pins form a pin density between about 10⁻⁴ and 10⁶ pins/mm².

12. The apparatus according to claim 1, further comprising a head member and at least a second pin, the pins forming an array, the pins of the array unitarily formed with the head member to define a first printhead.

13. The apparatus according to claim 12, further comprising a dispensing tray microfabricated from a polymeric material, the dispensing tray having an array of wells corresponding to the array of pins, for holding liquid to be transferred by the array of pins.

14. The apparatus according to claim 12, wherein the array of pins comprises up to 100,000 pins.

15. The apparatus according to claim 13, wherein the array of pins comprises up to 100,000 pins.

16. The apparatus according to claim 12, wherein the array of pins form a pin density between about 10⁻⁴ and 10⁶ pins/mm².

17. The apparatus according to claim 13, wherein the array of pins form a pin density between about 10⁻⁴ and 10⁶ pins/mm².

18. The apparatus according to claim 12, further comprising at least a second printhead assembled together with the first printhead to form a two dimensional array of the pins.

19. The apparatus according to claim 18, further comprising a holder for assembling the printheads together.

20. The apparatus according to claim 19, wherein the head members of the printheads are configured to self-align the printheads with the holder.

21. The apparatus according to claim 12, further comprising a holder for holding the first printhead.

22. The apparatus according to claim 21, wherein the head member is configured to self-align the first printhead relative to the holder.

23. The apparatus according to claim 1, wherein the predetermined volume comprises between about 0.1 mL and 10⁻⁴ pL.

24. The apparatus according to claim 1, wherein pin is capable of printing a spot having an area of about 10 mm² and 10⁻⁶ μm².

25. A pin comprising:
a tip; and
a fluid reservoir communicating with the tip,
wherein the pin is microfabricated from a polymeric material and is operative for transferring a predetermined volume of a fluid.

26. The pin according to claim 25, further comprising a head for suspending the pin in a holder.

27. The pin according to claim 26, wherein the tip of the pin is configured for printing or dispensing the fluid.

28. The pin according to claim 25, further comprising a spring opposite the tip for biasing the pin.

29. The pin according to claim 25, wherein the predetermined volume comprises between about 0.1 mL and 10⁻⁴ pL.

30. The pin according to claim 25, wherein pin is capable of printing a spot having an area of about 10 mm² and 10⁻⁶ μm².

31. A holder for use in fluid transfer and printing, the holder comprising:
a first member; and
a first aperture formed in the first member for receiving a microfabricated pin for transferring a predetermined volume of a fluid,
wherein the holder is microfabricated from a polymeric material.

32. The holder according to claim 31, further comprising at least a second aperture to form an array of apertures for receiving a microfabricated array of pins.

33. The holder according to claim 32, wherein the array of apertures comprises up to 100,000 apertures.

34. The holder according to claim 32, wherein the array of apertures form an aperture density between about 10⁻⁴ and 10⁶ apertures/mm².

35. The holder according to claim 31, further comprising:
a second member having a second aperture axially aligned with the first aperture.

36. A dispensing tray for use in fluid transfer and printing, the dispensing tray comprising:
a well for holding a fluid to be transferred by a microfabricated pin for transferring a predetermined volume of a fluid,
wherein the tray is microfabricated from a polymeric material.

37. The dispensing tray according to claim 36, further comprising at least a second well to form an array of wells for holding fluid to be transferred by a microfabricated array of pins.

38. The dispensing tray according to claim 37, wherein the array of wells comprises up to 100,000 wells.

39. The dispensing tray according to claim 37, wherein the array of wells form a well density between about 10⁻⁴ and 10⁶ wells/mm².

40. A method comprising steps of:
forming a positive mold of an article using a bulk micromachining process;
forming a negative mold of the article from the positive mold using an electroforming process; and
forming the article from a polymeric material in the negative mold, the polymeric article being operative for fluid transfer and printing.

41. The method according to claim 40, wherein the article comprises a pin for transferring a predetermined volume of a fluid.

42. The method according to claim 41, wherein the article further comprises a head member having surfaces for collimating the pin.

43. The method according to claim 41, wherein the article further comprises a head member and a spring coupling the pin to the head member.

44. The method according to claim 41, wherein the article further comprises at least a second pin, the pins forming an array.

45. The method according to claim 44, wherein the array of pins comprises up to 100,000 pins.

46. The method according to claim 44, wherein the array of pins form a pin density between about 10⁻⁴ and 10⁶ pins/mm².

47. The method according to claim 41, wherein the predetermined volume comprises between about 0.1 mL and 10⁻⁴ pL.

48. The method according to claim 41, wherein pin is capable of printing a spot having an area of about 10 mm² and 10⁻⁶ μm².

49. The method according to claim 41, wherein the article further comprises a head member and at least a second pin, the pins forming an array, the pins of the array being unitary with the head member to define a first printhead.

50. The method according to claim 49, further comprising the step of assembling at least a second printhead together with the first printhead to form a two dimensional array of the pins.

51. The method according to claim 41, wherein the pin includes a head for suspending the pin in a holder.

52. The method according to claim 51, wherein the pin further includes a tip for printing or dispensing a fluid.

53. The method according to claim 41, further comprising a spring opposite the tip for biasing the pin.

54. The method according to claim 40, wherein the article comprises a fluid dispensing tray, the dispensing tray having a well for holding a fluid to be handled by a microfabricated pin.

55. The method according to claim 54, wherein the dispensing tray further comprises at least a second well to form an array of wells for holding fluid to be handled by a microfabricated array of pins.

56. The method according to claim 55, wherein the array of wells comprises up to 100,000 wells.

57. The method according to claim 55, wherein the array of wells form a well density between about 10⁻⁴ and 10⁶ wells/mm².

58. The method according to claim 40, wherein the article comprises a holder comprising a first member and a first aperture formed in the first member for receiving a microfabricated pin.

59. The method according to claim 58, wherein the first member of the holder further comprises at least a second aperture to form an array of apertures for receiving a microfabricated array of pins.

60. The method according to claim 59, wherein the array of apertures comprises up to 100,000 apertures.

61. The method according to claim 59, wherein the array of apertures form an aperture density between about 10⁻⁴ and 10⁶ apertures/mm².

62. The method according to claim 40, further comprising the step of removing flashing from the article.

63. The method according to claim 62, wherein the flashing removing step is performed by at least one of die cutting, computer numerical controlled cutting, and grinding.

64. The method according to claim 40, further comprising the step of polishing surfaces of the article.

65. The method according to claim 64, wherein the polishing step is performed by a chemical polishing process.

66. The method according to claim 40, wherein the bulk micromachining process includes the step of micromachining a silicon wafer or substrate to form at least one mold section.

67. The method according to claim 66, wherein the positive first mold forming step further comprises the step of bonding the at least one mold section to a wafer or substrate.

68. The method according to claim 40, wherein the article forming step is performed by a molding process selected from the group consisting of casting, compression molding, stamping, and injection molding.

69. The method according to claim 40, wherein the polymeric material is selected from the group consisting of polycarbonates and polymethylmethacrylates, polyolefins, and polyetherketones.

70. The method according to claim 40, wherein the polymeric material comprises a thermoplastic polymer.

71. The method according to claim 40, wherein the negative second mold is formed of a metal.
